(19) United States
(12) Patent Application Publication
(10) Pub. No.: US 2006/0038936 A1
(43) Pub. Date: Feb. 23, 2006

(54) Liquid crystal display device and manufacturing method therefor

(75) Inventor: Jin Hirosawa, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignees: FUJITSU DISPLAY TECHNOLOGIES CORPORATION; AU OPTRONICS CORPORATION

(21) Appl. No.: 11/059,244

(22) Filed: Feb. 16, 2005

(30) Foreign Application Priority Data
Aug. 23, 2004 (JP) 2004-242337

(51) Int. Cl. G02F 1/1333

(52) U.S. Cl. 349/93

(57) ABSTRACT

To provide a liquid crystal display device having both high reliability and good optical characteristics, without conventionally used alignment control films. A liquid crystal composition comprising liquid crystal molecules and a polymerizable compound that can be polymerized by ultraviolet rays or a combination of the ultraviolet rays and heat is disposed between a pair of substrates. The polymerizable compound is polymerized by the ultraviolet rays irradiation having a 300-400 nm wavelength component to form a liquid crystal layer, and a polymer film to align the liquid crystal molecules vertically, on a liquid crystal layer contacting surface.

### CROSS-REFERENCE TO RELATED APPLICATIONS

This application is based upon and claims the benefit of priority from the prior Japanese Patent Application No. 2004-242337, filed on Aug. 23, 2004, the entire contents of which are incorporated herein by reference.

### BACKGROUND OF THE INVENTION

1. Field of the Invention

The present invention relates to a liquid crystal display device, and more particularly a liquid crystal display device using a property of liquid crystal molecules being in a vertically aligned state when no voltage is applied thereto.

2. Description of the Related Art

Conventionally, as active matrix liquid crystal displays (LCDs), there have been widely used TN (twisted nematic) mode liquid crystal display devices, in which a liquid crystal material having a positive dielectric anisotropy is aligned horizontally to a substrate surface, and twisted at 90 degrees between the substrates that face each other. However, this TN mode has a problem of insufficient viewing angle characteristics. Accordingly, a variety of studies have been made to improve the viewing angle characteristics.

As an alternative of the TN mode, an MVA (multi-domain vertical alignment) mode has been developed, in which a liquid crystal material having a negative dielectric anisotropy is vertically aligned, and the tilting direction of the liquid crystal molecules is regulated when voltage is applied by use of either protrusions provided on a substrate surface or cutouts of an electrode (slits). Remarkable improvement on the viewing angle characteristics has been successfully realized by this mode.

A liquid crystal panel based on the MVA mode is explained below, using examples shown in FIGS. 1A, 1B and 2. FIGS. 1A and 1B show schematic perspective views illustrating the alignment of liquid crystal molecules in a liquid crystal panel of an MVA mode liquid crystal display device. FIG. 2 shows a schematic plan view illustrating the alignment of liquid crystal molecules in the liquid crystal panel of the MVA mode liquid crystal display device.

In this liquid crystal panel of the MVA mode liquid crystal display device, liquid crystal molecules 1 having a negative dielectric anisotropy present between two glass substrates are vertically aligned when no voltage is applied, as shown in FIG. 1A. On one glass substrate 2, pixel electrodes connected to TFTs (thin film transistors, not shown in the figure) are formed; while a counter electrode is formed on the other glass substrate 3. Furthermore, uneven portions 4 are formed alternately on the pixel electrodes and the counter electrode.

When the TFTs are OFF, namely when no voltage is applied, the liquid crystal molecules are aligned in the direction vertical to the substrate boundary surface, as shown in FIG. 1A. When the TFTs are switched ON, namely when voltage is applied, the electric field influences the liquid crystal molecules to be tilted toward the horizontal direction, with the tilting direction of the liquid crystal molecules 1 being regulated by the structure of the uneven portions. This makes the liquid crystal molecules aligned in a plurality of directions within a single pixel, as shown in FIG. 1B. For example, when uneven portions 4 are formed as shown in FIG. 2, the liquid crystal molecules 1 are aligned in directions A, B, C and D, respectively. As such, in the MVA mode liquid crystal display device, it is possible to obtain satisfactory viewing angle characteristics, because the liquid crystal molecules are aligned in a plurality of directions when the TFTs are switched ON.

In the above-mentioned MVA mode, the tilting directions of the liquid crystal molecules are not regulated by alignment control film controls, and therefore, in some cases, it may be possible to omit alignment processes, represented by rubbing, which is almost inevitably necessary in a horizontal alignment mode represented by the TN mode. From the viewpoint of process ability, the problems of static electricity or dust accompanying the rubbing process can be avoided, and also cleaning processes after the alignment process become unnecessary. Furthermore, from the viewpoint of alignment, display unevenness caused by fluctuation of the pre-tilting angle can be eliminated. Thus, there is a merit of possible cost reduction through a simplified process and an improved production yield.

However, in the MVA mode, it is still necessary to provide alignment control films, leaving a cost problem unsolved. There has been proposed a method that a liquid crystal layer is formed by injecting and sealing a liquid crystal composition comprising a liquid crystal and a polymerizable compound into an MVA mode liquid crystal panel, and polymerization of the compound is performed by irradiating the liquid crystal layer with active energy rays. However, when alignment control films are not used, the retention rate of applied voltage is insufficient, and accordingly this method has not reached a stage of practical use. (see Japanese Unexamined Patent Application Publication No. Hei-7-43689, Hei-9-146068, and Hei-10-147783.)

Furthermore, considering that the present alignment control film printing devices would hardly cope with the sizes of mother glasses, which are presently increasing toward jumboization, use of alignment control films is going to a problem also from the viewpoint of coping with the jumboization of the mother glass.

### SUMMARY OF THE INVENTION

Considering the aforementioned problems, it is an object of the present invention to provide a technique for further improving liquid crystal display devices, particularly vertical alignment mode liquid crystal display devices represented by the MVA mode, and realizing liquid crystal display devices with high reliability and good optical characteristics for which alignment control film forming processes that have been considered inevitable so far, can be omitted. The other objects and advantages of the present invention will be clarified in the following explanation.

In one aspect of the present invention, a manufacturing method of a liquid crystal display device is provided in which a liquid crystal composition comprising liquid crystal molecules and a polymerizable compound that can be polymerized by ultraviolet rays or a combination of the ultraviolet rays and heat, is disposed between a pair of substrates; and the polymerizable compound is polymerized by irradiating ultraviolet rays including a wavelength component in the range of 300-400 nm, to form a liquid crystal layer, and a polymer film on a liquid crystal layer contacting surface to align the liquid crystal molecules in the vertical direction.

With the above aspect of the present invention, a highly reliable liquid crystal display device with good optical characteristics can be manufactured.

In another aspect of the present invention, a liquid crystal display device is provided, wherein a liquid crystal composition comprising liquid crystal molecules and a polymerizable compound that can be polymerized by ultraviolet rays or a combination of the ultraviolet rays and heat, has been disposed between a pair of substrates; and a liquid crystal layer is formed, and a polymer film is formed on a liquid crystal contacting surface to align the liquid crystal molecules in the vertical direction, by polymerizing the polymerizable compound by irradiating ultraviolet rays having a wavelength component in the range of 300-400 nm.

With the above aspect of the present invention, a highly reliable liquid crystal display device with good optical characteristics can be obtained.

Regarding the above-described aspects of the present invention, preferable are that the ultraviolet rays have been irradiated with the integrated intensity of a 300-350 nm wavelength component ranging from 0.01 to 10 mW/cm²; that the ultraviolet rays have been irradiated with the irradiation amount of a 300-350 nm wavelength component ranging from 1 to 2,000 mJ/cm²; that the ultraviolet rays have been irradiated with the integrated intensity of a 350-400 nm wavelength component ranging from 0.1 to 400 mW/cm²; that the ultraviolet rays have been irradiated with the irradiation amount of a 350-400 nm wavelength component ranging from 10 to 15,000 mJ/cm²; that the ultraviolet rays have been irradiated under a condition that the integrated intensity of a 300-350 nm wavelength component is 10% or less of the integrated intensity of a 350-400 nm wavelength component; and that the liquid crystal composition is disposed by one drop filling (or dropping injection).

By the present invention, liquid crystal display devices having high reliability and good optical characteristics are realized, without use of conventional alignment control films.

### BRIEF DESCRIPTION OF THE DRAWINGS

FIG. 1A shows a schematic perspective view illustrating alignment of liquid crystal molecules in a liquid crystal panel of an MVA mode liquid crystal display device;

FIG. 1B shows another schematic perspective view illustrating alignment of liquid crystal molecules in a liquid crystal panel of an MVA mode liquid crystal display device;

FIG. 2 shows a schematic plan view illustrating alignment of liquid crystal molecules in a liquid crystal panel of an MVA mode liquid crystal display device;

FIG. 3A shows a schematic diagram exemplifying the basic principle of the present invention;

FIG. 3B shows another schematic diagram exemplifying the basic principle of the present invention;

FIG. 4A shows another schematic diagram exemplifying the basic principle of the present invention; and

FIG. 4B shows another schematic diagram exemplifying the basic principle of the present invention.

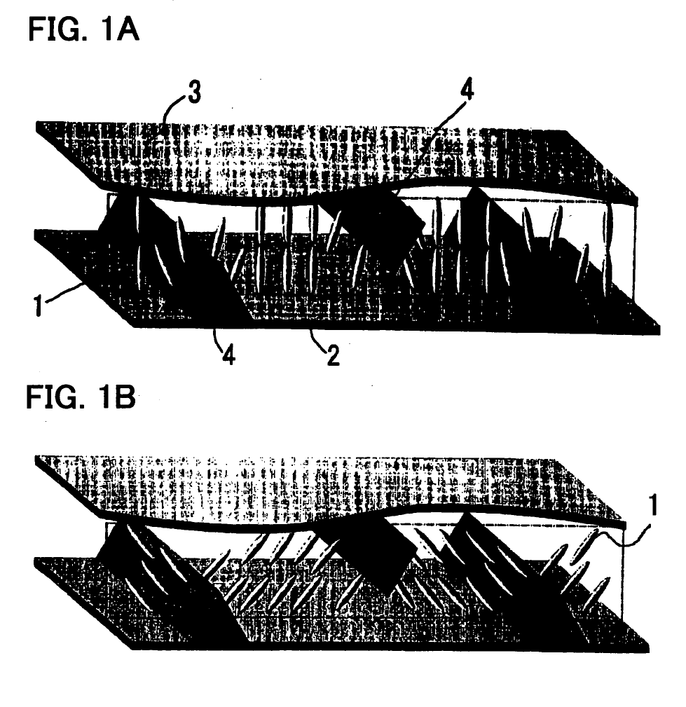

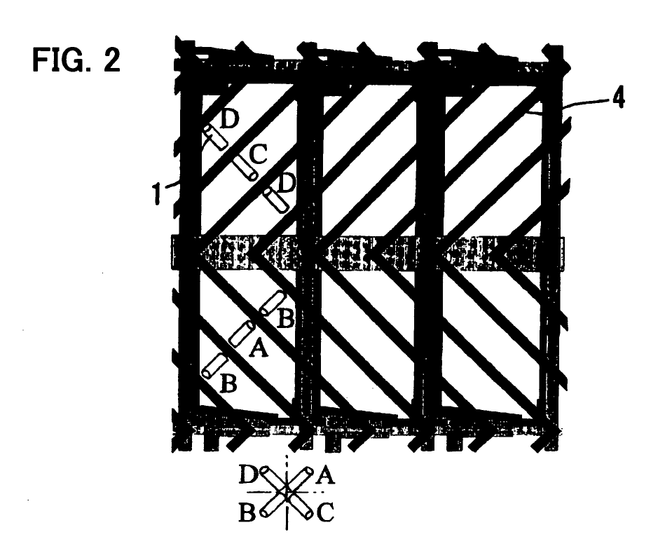

### DETAILED DESCRIPTION OF THE INVENTION

The preferred embodiments of the present invention are described hereinafter referring to the drawings, tables, examples, etc. However, such drawings, tables, examples, etc. are for the sake of exemplifying the present invention, and not intending to limit the scope of the invention. In the following drawings, like numerals refer to like elements.

According to a manufacturing method of a liquid crystal display device according to the present invention, a liquid crystal composition comprising liquid crystal molecules and a polymerizable compound that can be polymerized by ultraviolet rays or a combination of the ultraviolet rays and heat, is disposed between a pair of substrates; and the polymerizable compound is polymerized by irradiating ultraviolet rays, to form a liquid crystal layer, and a polymer film on a liquid crystal layer contacting surface to align the liquid crystal molecules in the vertical direction. Conventional alignment control films are not used. Instead, the polymer film has a function of an alignment control film to align the liquid crystal molecules in the direction vertical to the substrate. Two kinds of electrodes for switching the alignment direction of the liquid crystal molecules may be disposed either on the same substrate or on different substrates. When a liquid crystal having a negative dielectric anisotropy (negative type liquid crystal) is used, voltage may be applied when irradiating with the ultraviolet rays. However, to obtain better vertical alignment capability, preferably, the above procedure is performed under no voltage application. When a liquid crystal having a positive dielectric anisotropy (positive type liquid crystal) is used, voltage may not be applied when irradiating with the ultraviolet rays. However, to obtain better vertical alignment capability, preferably, the above procedure is performed under voltage application. As the liquid crystal type, negative type liquid crystals are preferable.

Here, in the present invention, the term ‘liquid crystal layer contacting surface’ does not simply mean the substrate surface, but the surface of a layer with which the liquid crystal layer actually comes in contact. For example, in a case in which the substrate and the liquid crystal layer are layered with a filter layer disposed therebetween, and actually the liquid crystal layer comes in contact with the surface of the filter, not the surface of the substrate, the liquid crystal layer contacting surface according to the present invention means the surface of the filter in contact with the liquid crystal. Also, if a hydrophilic processing is performed on the surface of the filter, the liquid crystal layer contacting surface is the processed surface.

The polymerizable compound according to the present invention has a molecular structure that can align, when polymerized, the liquid crystal molecules in the direction vertical to the substrate, by regulating the director direction of the liquid crystal molecules, and is a compound having a photoreactive group for polymerization by light. An alkyl chain is popular as a molecule structure capable of aligning the liquid crystal molecules to the direction vertical to the substrate, by regulating the director direction of the liquid crystal molecules. However, any other compound is applicable, as long as alignment of the liquid crystal molecules in the direction vertical to the substrate can be obtained as a result of polymerization. Alkyl groups having 6 to 18 carbon atoms are preferable.

The degree of aligning the liquid crystal molecules in the direction vertical to the substrate may be determined depending on the degree of light transmittance necessary for the liquid crystal display device. That is, it is not necessary to make the whole of the individual liquid crystal molecules disposed in the liquid crystal layer aligned in the vertical direction. The polymerizable compound according to the present invention may be either a so-called monomer, or oligomer.

Also, the photoreactive group of the polymerizable compound according to the present invention means a polymerizable functional group such as an acrylate group, methacrylate group, vinyl group, allyl group and epoxy group, which can be polymerized under the external influence of ultraviolet rays or a combination of ultraviolet rays and heat.

The polymerizable compound according to the present invention may be composed of a single component or a plurality of components. Preferably, the polymerizable compound is composed of a cross-linking component, or comprises a cross-linking component. The cross-linking component may be exemplified by a component that has a plurality of polymerizable functional groups in a molecule, such as an acrylate group, methacrylate group, epoxy group, vinyl group and allyl group, and has a structural portion that can polymerize with other molecules through irradiation with active energy rays such as ultraviolet, and/or heat. Here, a polymerizable compound having a ring structure such as an aromatic ring or an aliphatic ring is advantageous because of its higher polymerization reaction velocity. In Japanese Unexamined Patent Application Publication No. 2003-307720, polymerizable compounds that can be used in the present invention are exemplified.

The liquid crystal composition according to the present invention comprises the above-mentioned polymerizable composition and liquid crystal molecules. It may also comprise other components such as a catalyst.

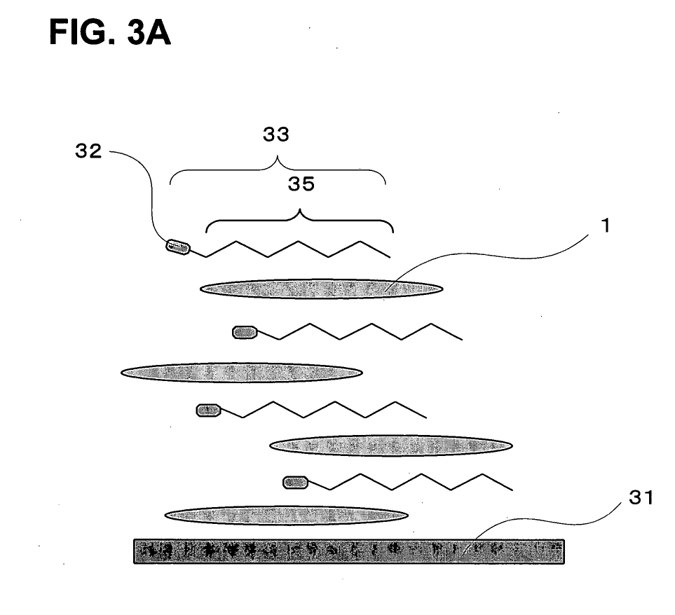

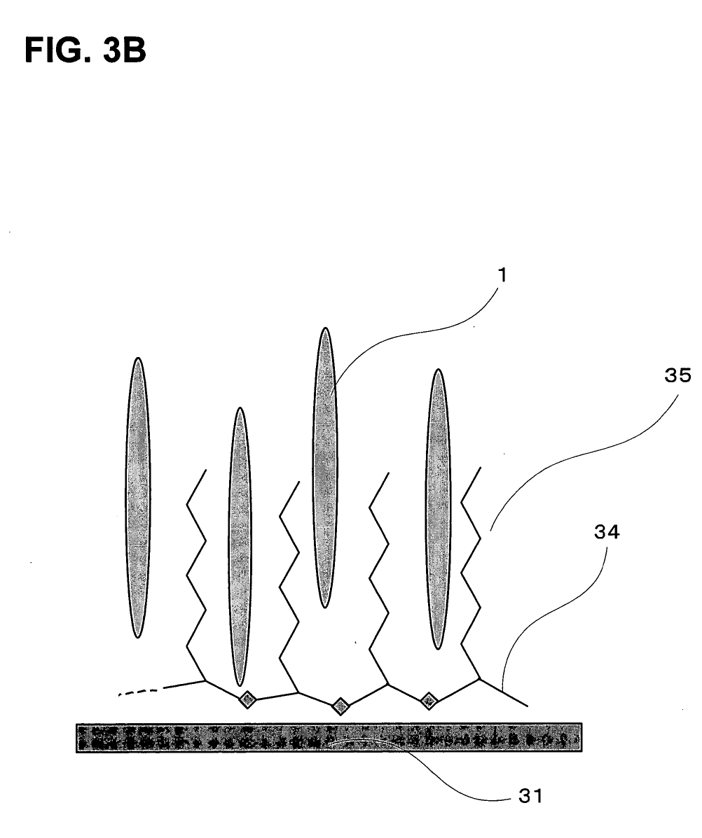

FIGS. 3A and 3B exemplify the basic principle of the present invention. In FIGS. 3A and 3B, a structure having a liquid crystal layer being directly in contact with a glass substrate is adopted. Accordingly, the surface of the substrate in contact with the liquid crystal layer is the liquid crystal layer contacting surface.

Immediately after the injection of the liquid crystal, liquid crystal molecules 1 in the liquid crystal layer are aligned horizontally as shown in FIG. 3A. Nothing is formed on the surface of substrate 31. Polymerizable compound molecules 33 according to the present invention that have photoreactive groups 32 are present as are dispersed in the liquid crystal layer.

When ultraviolet rays are irradiated in such a state, the polymerizable compound molecules 33 of the present invention are polymerized, and a polymer film 34 is formed to align the liquid crystal molecules 1 in the direction vertical to the substrate as shown in FIG. 3B, by regulating the director direction of the liquid crystal molecules 1. It is different from a so-called polymer dispersion liquid crystal (PDLC), which is a conventional system, and the alignment control is performed by a thin-film resin in a way similar to the alignment control films, rather than forming a polymer throughout the entire liquid crystal layer.

In FIGS. 3A and 3B, a monofunctional monomer 33 having a long-chain alkyl group 35 and a photoreactive group 32 is used as the polymerizable compound. In such a case, the polymer is not cross-linked, but has a straight-chain structure as shown in FIG. 3B, so that the polymer film is formed from the accumulated and entangled polymer molecules. It is also considered that, because of the repulsion against the glass substrate and the excellent affinity to the liquid crystal due to a lipophilic property of the long-chain alkyl group in the polymerizable compound, the polymer film has a structure in which the alkyl group rises from the substrate, as shown in FIG. 3B, which regulates the director direction of the liquid crystal molecules. However, it is not clear what mechanism actually causes the regulation of the director direction of the liquid crystal molecules according to the present invention, and it is supposed that the regulation may not be caused only by the structure of the alkyl group rising from the substrate. Accordingly, it is sufficient to consider that a polymer film according to the present invention is formed, if the liquid crystal molecules come to be aligned in the vertical direction as a result of polymerization.

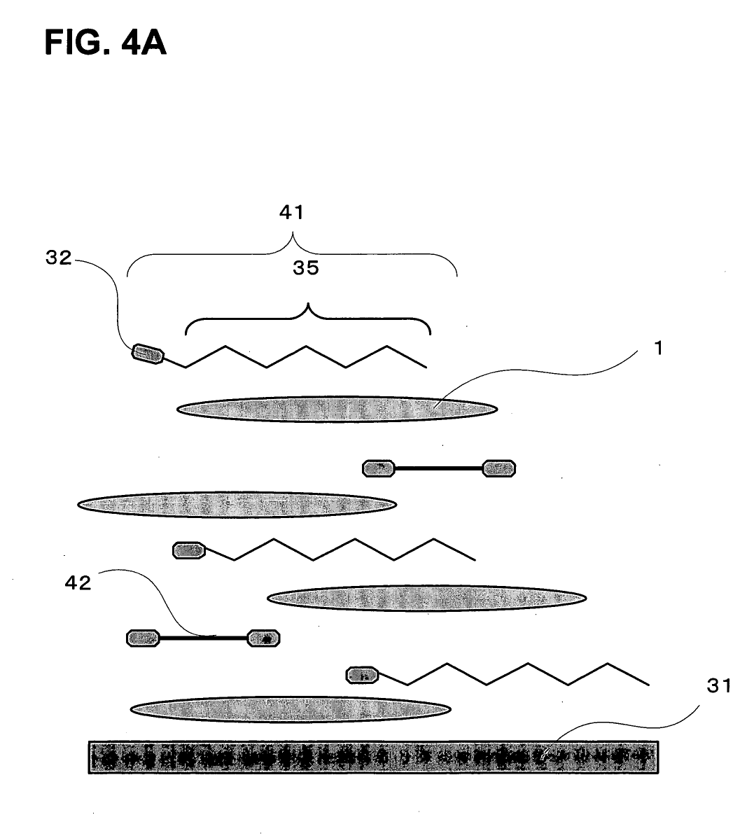

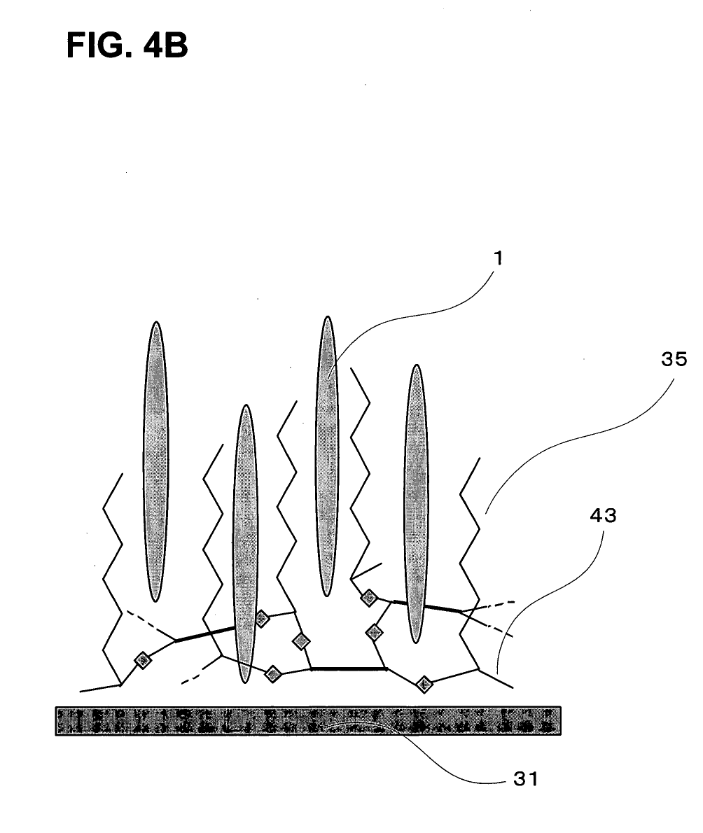

FIGS. 4A and 4B show another basic principle of the present invention. FIGS. 4A and 4B show examples in which a monofunctional monomer 41 having a long-chain alkyl group 35 and a photoreactive group 32, and a bifunctional monomer 42 as a cross-linking component are used as the polymerizable compounds. When a bifunctional monomer or monomer having more than two functional groups is used, the polymer is cross-linked, with a result that a three-dimensional network polymer film 43 is formed chemically, as shown in FIG. 4B. The film thus formed has a stronger film structure, and has higher reliability, that is, excellent voltage retention capability.

It has been found, however, that, even if the polymer film thus obtained is used, it is difficult to satisfy both high reliability and good optical characteristics simultaneously. The reason for this is assumed as follows: in a short irradiation time, it is difficult to sufficiently regulate the director direction of the liquid crystal molecules, and therefore, good optical characteristics may hardly be obtained; and in a long irradiation time, the polymerizable compound and/or the liquid crystal molecules are degenerated in quality, making it difficult to obtain high reliability.

After various trials, it has been found that a wavelength component in the range of 300-400 nm act an important role when polymerizing the polymerizable compound, and a highly reliable liquid crystal display device with good optical characteristics can be manufactured by choosing irradiation conditions with appropriate irradiation amounts and/or integrated amounts of a short-wavelength component and long-wavelength component, or appropriate ratios therebetween. A wavelength component in a range less than 300 nm has a strong tendency of degenerating the quality of the liquid crystal molecules, etc. Meanwhile, when the wavelength exceeds 400 nm, the liquid crystal molecules cannot be sufficiently aligned even in a long irradiation time. Here, the reliability in the present invention is evaluated by the degree of retaining the applied voltage (voltage retention rate) when a specific voltage is applied to a liquid crystal layer, as will be described later. Also the optical characteristics in the present invention are evaluated by the vertical alignment capability of the liquid crystal when no voltage is applied to a liquid crystal display device.

Regarding the wavelength component in the range of 300-400 nm, ultraviolet rays having a shorter wavelength is generally advantageous in view of realizing vertical alignment in the liquid crystal within a short time, while they tend to induce degeneration in quality of liquid crystal molecules, etc. To the contrary, degeneration in quality of the liquid crystal molecules, etc. is hard to occur by ultraviolet rays having a longer wavelength, while a long time is required to realize desired vertical alignment in the liquid crystal using such ultraviolet rays.

Preferably, the ultraviolet rays are irradiated with the integrated intensity of the 300-350 nm wavelength component ranging from 0.01 to 10 mW/cm². Furthermore, regarding the irradiation amount of the ultraviolet rays, preferably, the irradiation amount of the above wavelength range component is in the range of 1 to 2,000 mJ/cm². It is also preferable that both conditions are met. Here, the term ‘integrated intensity’ denotes a total intensity of the ultraviolet rays in a certain wavelength range.

Also, regarding the wavelength component in the range of 350-400 nm, the ultraviolet rays are preferably irradiated in the range of from 0.1 to 400 mW/cm² Regarding the irradiation amount, the ultraviolet rays are preferably irradiated in the range of from 10 to 15,000 mJ/cm². It is also preferable that both conditions be satisfied.

As a whole, it is preferable that the proportion of the integrated intensity of the 300-350 nm wavelength component is considerably smaller than the proportion of the integrated intensity of the 350-400 nm wavelength component. It has been found that a satisfactory result can be obtained by irradiating ultraviolet rays under a condition that the integrated intensity of the 300-350 nm wavelength component is not larger than 10% of the integrated intensity of the 350-400 nm wavelength component.

It has been found, as can be understood from the evaluations of reliability and vertical alignment capability, that the liquid crystal display device using the liquid crystal panel obtained by the manufacturing method of the present invention can furnish high reliability and good optical characteristics. Since conventional alignment control films can be omitted, the technique of the present invention is also excellent in coping with the presently on-going jumboization of mother glasses.

In the foregoing description, the explanation is made on a case where a negative type liquid crystal is used in an MVA mode. However, cases where positive type liquid crystals are used, or cases where modes other than the MVA mode are used, may, of course, be included within the scope of the present invention, since high reliability and good optical characteristics may be realized without applying conventional alignment control films.

Also, as a method for injecting the liquid crystal composition into a space between a pair of substrates, any method maybe adopted, including a vacuum injection method, a one drop filling method (or dropping injection method), etc. The one drop filling method is a method in which a liquid crystal composition is injected dropwise to form dots of the composition or the similar shapes, on either one of the substrates, or on both substrates. It has been found that drop spots which would appear when alignment control films are applied, can be eliminated if the present invention is applied. Here, drop spots represents a phenomenon that the spots where the liquid crystal composition droplets have been formed, come to appear in white when black is displayed.

### EXAMPLES

Next, examples will be described hereafter in detail, in which the following evaluation methods were applied. In the entire following cases, the ultraviolet rays were irradiated at room temperature.

<Reliability>

A voltage retention rate after a retention time of 1,667 ms was measured against an applied voltage of 5.5 V, using a measurement system VHR-1 manufactured by Toyo Corporation.

<Vertical Alignment Capability>

It was evaluated by the transmittance of visible light when black was displayed without applying voltage. The smaller the transmittance is, the better the vertical alignment capability is.

### Example 1

Polymerizable compounds according to the present invention composed of a monofunctional monomer having an alkyl long-chain with the number of CH₂ being in the range of from 11 to 18 and an acrylate group, and a diacrylate bifunctional monomer having a ring structure, as well as a polymerization initiator were dissolved into a negative type liquid crystal A manufactured by Merck KGaA to form a liquid crystal composition.

ITO film electrodes were provided on the internal surfaces of two, upper and lower, glass substrates, a seal of a thermosetting resin was provided, and the above-mentioned liquid crystal composition was injected into the space under vacuum to form a 15-type liquid crystal panel. A cell thickness was set to be 4.25 μm. Alignment control films were not formed.

When the alignment statuses of such liquid crystal panels were observed immediately after the fabrication, mobile alignment was found in which horizontal alignment was mixed with vertical alignment. Thereafter, the liquid crystal panels were subjected to annealing treatment at 90° C. for 30 minutes. After cooling, non-polarized ultraviolet rays including a 300-400 nm wavelength component were irradiated in an amount of 9,000 mJ/cm² for one hour without applying voltage. As a result of observation of the alignments, vertical alignment was found throughout the liquid crystal panel areas. Table 1 shows the relationships between the presence/absence of the 300-400 nm wavelength component, and the reliability and vertical alignment capability. The reliability was low under irradiation conditions with wavelengths shorter than 300 nm. Under irradiation conditions with wavelengths longer than 400 nm, satisfactory vertical alignment was not obtained, in an irradiation time of two hours that can be applied to actual manufacturing processes. To contrast, under the irradiation conditions with the wavelength in the range of 300-400 nm, liquid crystal panels having high reliability and satisfactory vertical alignment capability were obtained.

TABLE 1
Change in reliability and vertical alignment
capability caused by the presence/absence of the
300-400 nm wavelength component

| | Reliability | Vertical alignment |
|---|---|---|
| Irradiation | (voltage retention | capability |
| condition | rate, %) | (transmittance, %) |
| Wavelength | 97.5 | 0.014 |
| component | | |
| 300-400 nm | | |
| Wavelength | 67.2 | 0.0022 |
| component | | |
| below 300 nm | | |
| Wavelength | 87.9 | 3.4 |
| component | | |
| over 400 nm | | |

### Example 2

In this experiment similar to EXAMPLE 1, the irradiation was performed with the integrated intensity of the 300-350 nm wavelength component ranging from 0.008 to 12 mW/cm². In the range of from 0.01 to 10 mW/cm², it was possible to obtain satisfactory liquid crystal panels in both reliability and vertical alignment capability. Also, as a result of evaluating the relationship with the irradiation amount, it was found that an irradiation amount of from 1 to 2,000 mJ/cm² was preferable for the 300-350 nm wavelength component.

The relationships between the integrated intensity of the 300-350 nm wavelength component, and the reliability and vertical alignment capability are shown in Table 2. Furthermore, the relationships between the irradiation amount of the 300-350 nm wavelength component, and the reliability and vertical alignment capability are shown in Table 3.

TABLE 2
Relationships between the integrated intensity
of the 300-350 nm wavelength component, and the
reliability and vertical alignment capability

| Integrated | Reliability | Vertical alignment |
|---|---|---|
| intensity | (voltage retention | capability |
| (mW/cm²) | rate, %) | (transmittance, %) |
| 0.008 | 96.8 | 2.1 |
| 0.012 | 97.1 | 0.027 |
| 1 | 97.0 | 0.01 |
| 8 | 96.5 | 0.014 |
| 12 | 94.8 | 0.012 |

TABLE 3
Relationships between the irradiation amount of
the 300-350 nm wavelength component, and the
reliability and vertical alignment capability

| Irradiation | Reliability | Vertical alignment |
|---|---|---|
| amount | (voltage retention | capability |
| (mJ/cm²) | rate, %) | (transmittance, %) |
| 0.8 | 95.9 | 1.8 |
| 1.2 | 96.2 | 0.03 |
| 1,000 | 97.1 | 0.015 |
| 1,800 | 96.5 | 0.01 |
| 2,200 | 94.2 | 0.011 |

### Example 3

In this experiment similar to EXAMPLE 1, the irradiation was performed with the integrated intensity of the 350-400 nm wavelength component ranging from 0.08 to 420 mW/cm². In the range of from 0.1 to 400 mW/cm², satisfactory liquid crystal panels were obtained in both reliability and vertical alignment capability. It was also found that an irradiation amount of from 10 to 15,000 mJ/cm² was preferable for the 350-400 nm wavelength component.

The relationships between the integrated intensity of the 350-400 nm wavelength component, and the reliability and vertical alignment capability are shown in Table 4. Furthermore, the relationships between the irradiation amount of the 350-400 nm wavelength component, and the reliability and vertical alignment capability are shown in Table 5.

TABLE 4
Relationships between the integrated intensity
of the 350-400 nm wavelength component, and the
reliability and vertical alignment capability

| Integrated | Reliability | Vertical alignment |
|---|---|---|
| intensity | (voltage retention | capability |
| (mW/cm²) | rate, %) | (transmittance, %) |
| 0.08 | 96.1 | 3.4 |
| 0.12 | 96.1 | 0.032 |
| 10 | 96.5 | 0.027 |
| 380 | 96.2 | 0.014 |
| 420 | 94.4 | 0.01 |

TABLE 5
Relationships between the irradiation amount of
the 350-400 nm wavelength component, and the
reliability and vertical alignment capability

| Irradiation | Reliability | Vertical alignment |
|---|---|---|
| amount | (voltage retention | capability |
| (mJ/cm²) | rate, %) | (transmittance, %) |
| 8 | 96.2 | 2.5 |
| 12 | 96.3 | 0.024 |
| 5,000 | 97.1 | 0.027 |
| 13,000 | 96.5 | 0.018 |
| 17,000 | 94.5 | 0.013 |

### Example 4

Regarding the experiments performed under conditions similar to that for EXAMPLE 1, except that the irradiation amount of the 300-350 nm wavelength component ranged from 700 to 7,000 mJ/cm², and that the irradiation amount of the 350-400 nm wavelength component was 14,000 mJ/cm², the influence of the ratio between the integrated intensity of the 300-350 nm wavelength component to the integrated intensity of the 350-400 nm wavelength component was studied. As a result, as shown in Table 6, when the irradiation was performed under a condition that the integrated intensity of the 300-350 nm wavelength component was10% or less of that of the 350-400nm wavelength component, liquid crystal panels having satisfactory reliability and vertical alignment capability could be obtained.

TABLE 6
Relationships between integrated intensity of the
300-350 nm wavelength component + integrated intensity
of the 350-400 nm wavelength component, and the
reliability and vertical alignment capability

| Integrated | Reliability | Vertical alignment |
|---|---|---|
| intensity | (voltage retention | capability |
| (mW/cm²)* | rate, %) | (transmittance, %) |
| 0.51 | 70.2 | 0.020 |
| 0.21 | 81.5 | 0.015 |
| 0.081 | 95.8 | 0.018 |
| 0.031 | 97.2 | 0.014 |

*Upper entries show the integrated intensities of the 300-350 nm wavelength component, and the lower entries, the integrated intensities of the 350-400 nm wavelength component.

### Example 5

Liquid crystal panels were fabricated in a similar way to EXAMPLE 1, except that a one drop filling method was applied for injecting the liquid crystal composition in this experiment. As a result of irradiation on these panels in a similar way to those shown in EXAMPLEs 1-4, satisfactory liquid crystal panels were obtained in both reliability and vertical alignment capability. Furthermore, in the method according to the present invention, drop spots were not found, while they were found when alignment control films were used.

What is claimed is:

1. A manufacturing method of a liquid crystal display device wherein:
a liquid crystal composition comprising liquid crystal molecules and a polymerizable compound that can be polymerized by ultraviolet rays or a combination of ultraviolet rays and heat, is disposed between a pair of substrates; and
said polymerizable compound is polymerized by irradiating ultraviolet rays including a wavelength component in the range of 300-400 nm, to form a liquid crystal layer, and a polymer film on a liquid crystal layer contacting surface to align the liquid crystal molecules in the vertical direction.

2. The manufacturing method of the liquid crystal display device according to claim 1,
wherein the ultraviolet rays are irradiated with the integrated intensity of a 300-350 nm wavelength component ranging from 0.01 to 10 mW/cm².

3. The manufacturing method of the liquid crystal display device according to claim 1,
wherein the ultraviolet rays are irradiated with the irradiation amount of a 300-350 nm wavelength component ranging from 1 to 2,000 mJ/cm².

4. The manufacturing method of the liquid crystal display device according to claim 1,
wherein the ultraviolet rays are irradiated with the integrated intensity of a 350-400 nm wavelength component ranging from 0.1 to 400 mW/cm².

5. The manufacturing method of the liquid crystal display device according to claim 1,
wherein the ultraviolet rays are irradiated with the irradiation amount of a 350-400 nm wavelength component ranging from 10 to 15,000 mJ/cm².

6. The manufacturing method of the liquid crystal display device according to claim 1,
wherein the ultraviolet rays are irradiated under a condition that the integrated intensity of a 300-350 nm wavelength component is 10% or less of the integrated intensity of a 350-400 nm wavelength component.

7. The manufacturing method of the liquid crystal display device according to claim 1,
wherein the liquid crystal composition is disposed by one drop filling.

8. A liquid crystal display device wherein:
a liquid crystal composition comprising liquid crystal molecules and a polymerizable compound that can be polymerized by ultraviolet rays or a combination of the ultraviolet rays and heat, has been disposed between a pair of substrates; and
a liquid crystal layer is formed, and a polymer film is formed on a liquid crystal contacting surface to align the liquid crystal molecules in the vertical direction, by polymerizing said polymerizable compound by irradiating ultraviolet rays having a wavelength component in the range of 300-400 nm.

9. The liquid crystal display device according to claim 8,
wherein the ultraviolet rays have been irradiated with the integrated intensity of a 300-350 nm wavelength component ranging from 0.01 to 10 mW/cm².

10. The liquid crystal display device according to claim 8,
wherein the ultraviolet rays have been irradiated with the irradiation amount of a 300-350 nm wavelength component ranging from 1 to 2,000 mJ/cm².

11. The liquid crystal display device according to claim 8,
wherein the ultraviolet rays have been irradiated with the integrated intensity of a 350-400 nm wavelength component ranging from 0.1 to 400 mW/cm².

12. The liquid crystal display device according to claim 8,
wherein the ultraviolet rays have been irradiated with the irradiation amount of a 350-400 nm wavelength component ranging from 10 to 15,000 mJ/cm².

13. The liquid crystal display device according to claim 8,
wherein the ultraviolet rays have been irradiated under a condition that the integrated intensity of a 300-350 nm wavelength component is 10% or less of the integrated intensity of a 350-400 nm wavelength component.

14. The liquid crystal display device according to claim 8,
wherein the liquid crystal composition is disposed by one drop filling.
